(19) United States
(12) Patent Application Publication
(10) Pub. No.: US 2009/0240546 A1
(43) Pub. Date: Sep. 24, 2009

(54) Workflow management system

(75) Inventor: HIDEO SATO, Kanagawa (JP)

Correspondence Address: HARNESS, DICKEY & PIERCE, P.L.C., P.O. BOX 8910, RESTON, VA, 20195, US

(73) Assignee: RICOH COMPANY, LTD.

(21) Appl. No.: 12/382,285

(22) Filed: Mar. 12, 2009

(30) Foreign Application Priority Data
Mar. 18, 2008 (JP) 2008-070376

(51) Int. Cl. G06Q 10/00

(52) U.S. Cl. 705/8

(57) ABSTRACT

A disclosed workflow management system includes a skill input unit through which skill information is input; an experience value update unit updating the skill information of an executor of a task; a task information acquisition unit acquiring task information including at least a task name and detailed information; a skill profile information input unit from which skill profile information including at least a skill name is input; a similar task search unit searching for an existing similar task; an associated person acquisition unit acquiring an associated person of the task; a confirmation unit confirming whether the associated person has consistency with the skill profile information; a skill search unit searching for human resources having a common skill; and an integration unit calculating a ranking of the human resources or the tasks and presenting the calculated rankings in descending order.

### BACKGROUND OF THE INVENTION

1. Field of the Invention

The present invention relates to a workflow management system that dynamically constitutes a workflow model at the execution of a workflow.

2. Description of the Related Art

At the generation of individual tasks (including sub-tasks) constituting a workflow, it is necessary to search for appropriate persons such as those to whom the execution of the tasks are delegated, those as actual members who perform operations in accordance with the tasks, and those who can give feedback. Therefore, there has been a growing demand for easily searching for appropriate human resources. Patent Documents 1 through 4 disclose techniques for managing human resources in consideration of skills.

In addition, there has been a growing demand for easily searching for existing similar tasks from the viewpoint of reuse and reference. In this case, it is desired that not only tasks similar in titles (task names) and descriptions but also various and useful existing tasks be presented as candidates so as to be used for reuse and reference information.

Patent Document 1: JP-A-2004-118648

Patent Document 2: JP-A-2001-338097

Patent Document 3: JP-A-2006-244000

Patent Document 4: JP-A-2005-327028

However, conventional workflow management systems are not satisfactory in terms of functions for searching for appropriate human resources and useful tasks as reference information, which in turn does not adequately respond to user demands.

### SUMMARY OF THE INVENTION

Accordingly, the present invention has been made in light of the above drawback and may provide a workflow management system capable of easily searching for and presenting appropriate human resources or tasks.

According to an aspect of the present invention, there is provided a workflow management system that dynamically constitutes a workflow model for executing a workflow. The system includes a skill input unit through which skill information necessary for executing a new task is input for generating the new task; an experience value update unit that calculates an experience value based on time from a start of the task to an end thereof at the ending of the task and updates the skill information of an executor of the task; a task information acquisition unit that acquires task information including at least a task name and detailed information from a task in operation at a request of searching for a human resource or a task; a skill profile information input unit from which skill profile information including at least a skill name is input at the request; a similar task search unit that searches for an existing similar task based on the task information; an associated person acquisition unit that acquires an associated person of the task searched for by the similar task search unit; a confirmation unit that performs confirmation whether the associated person acquired by the associated person acquisition unit has consistency with the skill profile information; a skill search unit that searches for the human resources having a common skill based on the skill profile information; and an integration unit that calculates rankings of the human resources or the tasks in consideration of the experience value based on an output from the confirmation unit and an output from the skill search unit and presents the calculated rankings in descending order.

According to another aspect of the present invention, there is provided a workflow management method for controlling a workflow management system that dynamically constitutes a workflow model for executing a workflow. The method includes a skill input step of inputting skill information necessary for executing a new task for generating the new task; an experience value update step of calculating an experience value based on time from a start of the task to an end thereof at the end of the task and updating the skill information of an executor of the task; a task information acquisition step of acquiring task information including at least a task name and detailed information from a task in operation at a request of searching for a human resource or a task; a skill profile information input step of inputting skill profile information including at least a skill name at the request; a similar task search step of searching for an existing similar task based on the task information; an associated person acquisition step of acquiring an associated person of the task searched for in the similar task search step; a confirmation step of performing confirmation whether the associated person acquired in the associated person acquisition step has consistency with the skill profile information; a skill search step of searching for the human resources having a common skill based on the skill profile information; and an integration step of calculating a ranking of the human resources or the tasks in consideration of the experience value based on an output in the confirmation step and an output from the skill search step and presenting the calculated rankings in descending order.

According to still another aspect of the present invention, there is provided a recording medium having recorded thereon a computer-readable workflow control program of a workflow management system that dynamically constitutes a workflow model for executing a workflow. The control program causes a computer constituting the workflow management system to function as a skill input unit through which skill information necessary for executing a new task is input for generating the new task; an experience value update unit that calculates an experience value based on time from a start of the task to an end thereof at the ending of the task and updates the skill information of an executor of the task; a task information acquisition unit that acquires task information including at least a task name and detailed information from a task in operation at a request of searching for a human resource or a task; a skill profile information input unit from which skill profile information including at least a skill name is input at the request; a similar task search unit that searches for an existing similar task based on the task information; an associated person acquisition unit that acquires an associated person of the task searched for by the similar task search unit; a confirmation unit that performs confirmation whether the associated person acquired by the associated person acquisition unit has consistency with the skill profile information; a skill search unit that searches for the human resources having a common skill based on the skill profile information; and an integration unit that calculates a ranking of the human resources or the tasks in consideration of the experience value based on an output from the confirmation unit and an output from the skill search unit and presents the calculated rankings in descending order.

Other objects, features and advantages of the present invention will become more apparent from the following detailed description when read in conjunction with the accompanying drawings.

### BRIEF DESCRIPTION OF THE DRAWINGS

FIG. 1 is a diagram showing a configuration example of a workflow management system according to an embodiment of the present invention;

FIG. 2 is a diagram showing an installation example of the workflow management system;

FIG. 3 is a diagram showing a constructional example of a workflow;

FIG. 4 is a diagram showing a data constructional example of a task instance DB;

FIGS. 5A and 5B are diagrams showing a data constructional example of a skill information DB;

FIG. 6 is a sequence diagram showing a processing example at the generation and ending of tasks in this embodiment;

FIG. 7 is a diagram showing an example of setting a skill experience;

FIG. 8 is a sequence diagram showing a processing example at a search in the above embodiment;

FIG. 9 is a diagram showing an example of a search screen;

FIG. 10 is a diagram showing information (data) and the flow of processing at the search in the embodiment; and

FIG. 11 is a diagram showing an example of an integration result of an embodiment.

### DETAILED DESCRIPTION OF THE PREFERRED EMBODIMENTS

Hereinafter, a description is made of a preferred embodiment of the present invention.

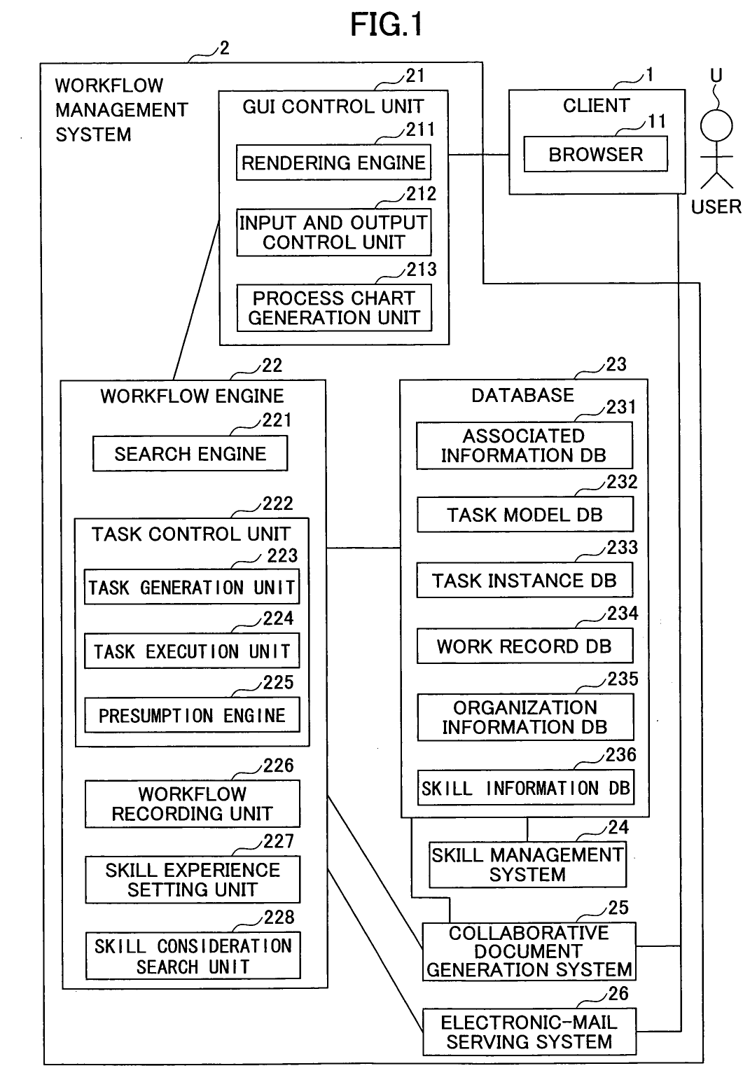

FIG. 1 is a diagram showing a configuration example of a workflow management system according to an embodiment of the present invention.

In FIG. 1, a workflow management system 1 has a GUI (Graphical User Interface) control unit 21, a workflow engine 22, a database 23, a skill management system 24, a collaborative document generation system 25, and an electronic-mail serving system 26. The GUI control unit 21 provides a GUI in response to an access via a browser 11 of a client 1 such as a PC (Personal Computer) operated by the user U using a system. The workflow engine 22 dynamically generates and executes a workflow model by reusing existing task models and/or task instances. The database 23 maintains information necessary for performing processing. The skill management system 24 manages the skill information of human resources allocated to the tasks constituting a workflow. The collaborative document generation system 25 is configured as a CMS (Content Management System) such as a Wiki. The electronic-mail serving system 26 has the function of sending and receiving electronic mail.

The database 23 has an associated information DB 231, a task model DB 232, a task instance DB 233, a work record DB 234, an organization information DB 235, and a skill information DB 236. The associated information DB 231 stores associated information referred to when a workflow is executed. The task model DB 232 stores task models abstracted in advance by a manager or the like. The task instance DB 232 stores task instances previously or currently used in an actual workflow. The work record DB 234 stores the work records of a work flow. The organization information DB 235 stores information on users and groups to which the users belong. The skill information DB 236 stores the skill information of human resources. The task model DB 232 and task instance DB 233 are linked to the information registered in the associated information DB 231.

The GUI control unit 21 has a rendering engine 211, an input and output control unit 212, and a process chart generation unit 213. The rendering engine 211 is used for rendering a display screen. The input and output control unit 212 exchanges information with the user U. The process chart generation unit 213 generates a process chart in which a workflow is visualized.

The workflow engine 22 has a search engine 221, a task control unit 222, a workflow recording unit 226, a skill experience setting unit 227, and a skill consideration search unit 228. The search engine 221 conducts various searches with respect to the database 23. The task control unit 222 controls tasks constituting a workflow. The workflow recording unit 226 refers to the database 23 and monitors the operations of the user U and the workflow management system 2 to store the workings of a workflow in the work record DB 234. The skill experience setting unit 227 sets up (updates) the experience value of the skill information of a task executor at the end of a task in accordance with necessary skills input when the new task is generated. The skill consideration search unit 228 searches for experts (persons) or tasks in consideration of skills and presents a result to the user U. Note that the skill consideration search unit 28 uses the function of the search engine 221 to conduct a search with respect to the database 23.

The task control unit 222 has a task generation unit 223, a task execution unit 224, and a presumption engine 225. The task generation unit 223 generates tasks. The task execution unit 224 executes generated tasks. The presumption engine 225 presumes the current tasks of the user U based on the information stored in the work record DB 234 and searches for associated information from the database 23.

The workflow management system 2 enables the integration of predetermined workflow parts (typical partial workflows), thereby realizing the dynamic definition (constructive workflow) of a workflow. In a field in which completeness in prior information is reduced, such as research and development or some service trades, it is hard to design a workflow model in advance. By dynamically constituting a model at the execution of a workflow as described above, however, it is possible to make a flexible response.

In addition, the workflow management system 2 can generate a workflow with the WBS (Work Breakdown Structure) and easily delegate tasks. Moreover, the workflow management system 2 has the function of presenting necessary information to the user who executes tasks as occasion demands.

As a basic operating outline for controlling a workflow, the user U operates the workflow engine 22 via the input and output control unit 212 of the GUI control unit 21 to generate and execute the workflow, generate a workflow model, register associated information and documents, and link them to workflow instances and the workflow models.

At the generation of a workflow, the search engine 221 of the workflow engine 22 conducts various searches with respect to the database 23.

The task control unit 222 controls tasks based on instructions or the like from the user U by using the task model DB 232 and the task instance DB 233. The task generation unit 223 of the task control unit 222 generates tasks and links information between them based on the information stored in the database 23 in accordance with instructions from the user U. The task execution unit 224 uses the information stored in the task instance DB 233 in accordance with instructions from the user U and executes actual task information (it can be said that the task execution unit 224 updates task information when viewed from the side of a system). The presumption engine 225 presumes the current tasks of the user U based on the information stored in the work record DB 234 and searches for associated information from the database 23.

The workflow recording unit 226 monitors the operations of the user U and the workflow management system 2 and stores the work records of a workflow in the work record DB 234.

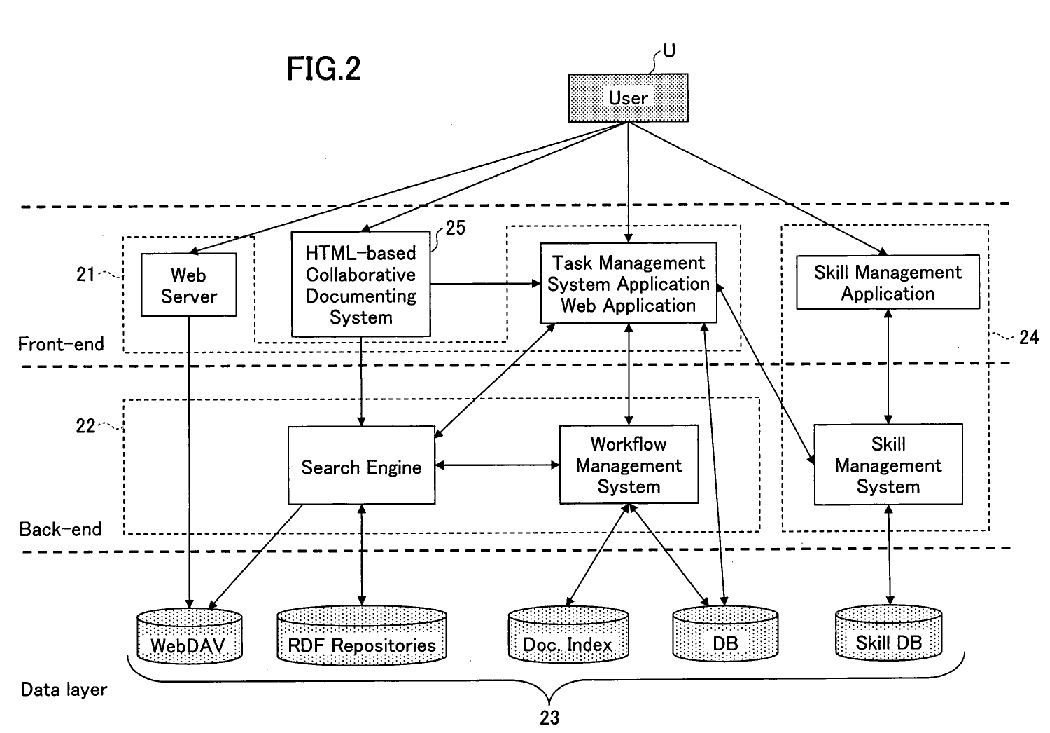

FIG. 2 is a diagram showing an installation example of the workflow management system 2. Here, a “Web Server” and a “Task Management System Application Web Application” correspond to the GUI control unit 21. Furthermore, an “HTML-based Collaborative Documenting System” corresponds to the collaborative document generation system 25. Furthermore, a “Skill Management Application” and a “Skill Management System” correspond to the skill management system 24. Furthermore, the “Web Server,” the “HTML-based Collaborative Documenting System,” the “Task Management System Application Web Application,” and the “Skill Management Application” constitute a Front-end. In other words, the workflow management system 2 has the Web server and the HTML-based collaborative document generation system so that the user U can access the system using the Web browser (browser 11). Furthermore, since it is assumed that the user U accesses the system using the Web browser in this installation of the workflow management system 2, it is necessary to manage user's access to files on a network. Here, a file management system on the network such as NetDrive is used for realizing this function.

Furthermore, the “Workflow Management System” and the “Search Engine” correspond to the workflow engine 22. The “Workflow Management System,” the “Search Engine,” and the “Skill Management System” of the skill management system 24 constitute a Back-end. The basic function for managing a workflow is the same as those of conventional systems. Therefore, the engine of a general workflow management system can be applied to the system of the present invention. As the search engine for searching for tasks and associated information, search engines based on general queries can be used.

Furthermore, a “WebDAV,” “RDF Repositoreis,” a “Doc.Index,” a “DB,” and a “Skill DB” correspond to the database 23 and constitute a data layer. Task information and associated information are managed by the RDF repositories, and the associated information or the like are managed by a document repository and an index server. The former corresponds to the task model DB 232 and the task instance DB 233 of FIG. 1, and the latter corresponds to the associated information DB 231. User information and organization information are also managed by RDF repositories. The task model DB 232 and the task instance DB 233 correspond to the organization DB 235 in FIG. 1.

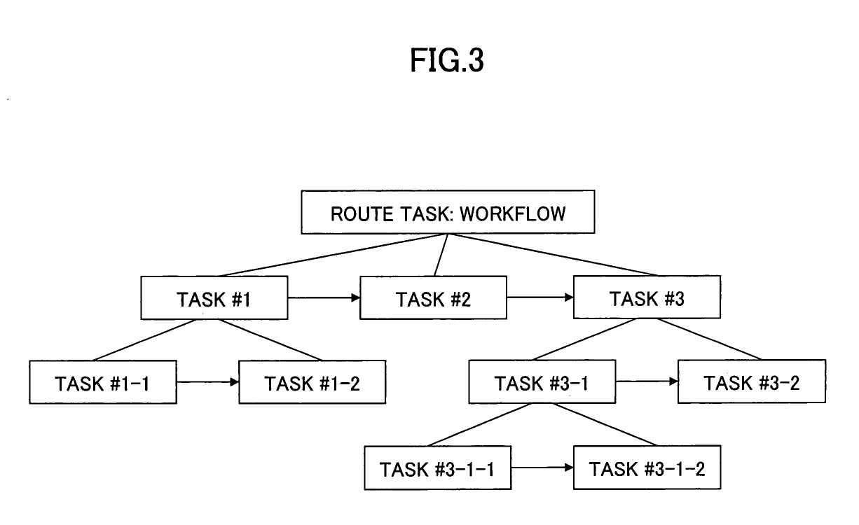

FIG. 3 is a diagram showing a constructional example of a workflow. In FIG. 3, the workflow (project) as a route task is composed of an arbitrary number of tasks (for example, tasks #1 through #3). Each of the tasks can be further composed of an arbitrary number of sub-tasks (for example, sub-tasks #1-1, #1-2, #3-1, #3-2, #3-1-1, and #3-1-2) and stratified. In other words, the workflow can have plural tasks, and each of the tasks can have plural sub-tasks. Order relationships (as indicated by arrows in FIG. 3) between the tasks and between the sub-tasks are the same as those of a general workflow management system. Furthermore, each of the tasks and the sub-tasks can have associated information and associated documents.

Task instances represent tasks as substances individually managed, and task models or process types represent substances serving as templates of the task instances and as models having high abstractiveness.

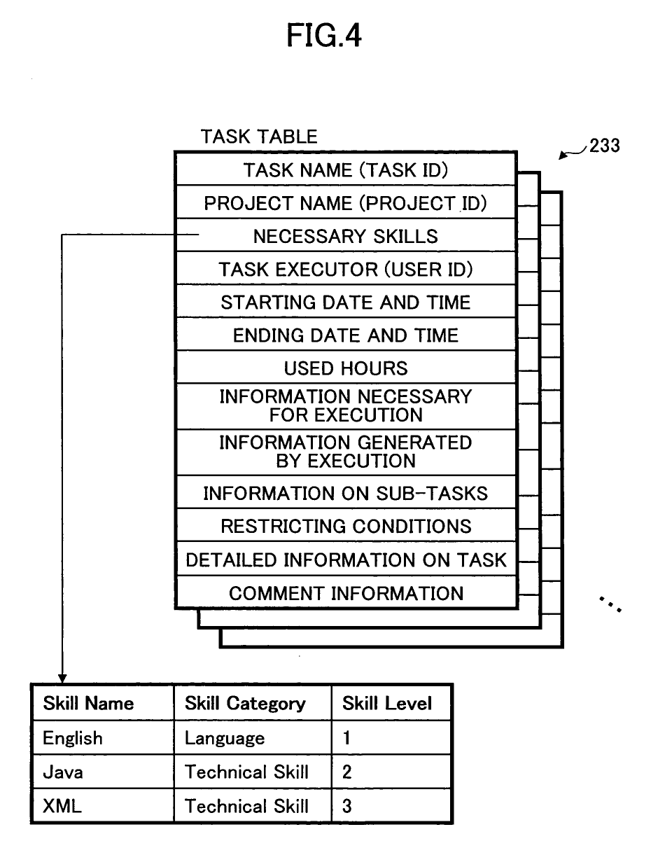

FIG. 4 is a diagram showing a data constructional example of the task instance DB 233 and includes task tables for respective tasks. Each of the task tables includes a “task name (task ID)” for specifying a task, a “project name (project ID)” for specifying a project to which the task belongs, a “necessary skills” showing skills demanded when the task is executed, and a “task executor (user ID)” for specifying the executor of the task. The necessary skills have the items of a “Skill Name,” a “Skill Category,” and a “Skill Level.”

In addition, each of the task tables includes a “starting date and time” showing the starting date and time of the task; an “ending date and time” showing the ending date and time of the task; and “used hours” showing time from the start to the end of the task; “information necessary for execution” showing the whereabouts of information necessary for executing the task; “information generated by execution” showing the whereabouts of documents or the like generated by the execution of the task; “information on sub-tasks” showing IDs or the like of the sub-tasks of the task; “restricting conditions” showing conditions for executing the task; “detailed information on task” describing the contents of the task; and “comment information” showing the information (the contents of comments and commentators (user IDs)) of the comments added to the task.

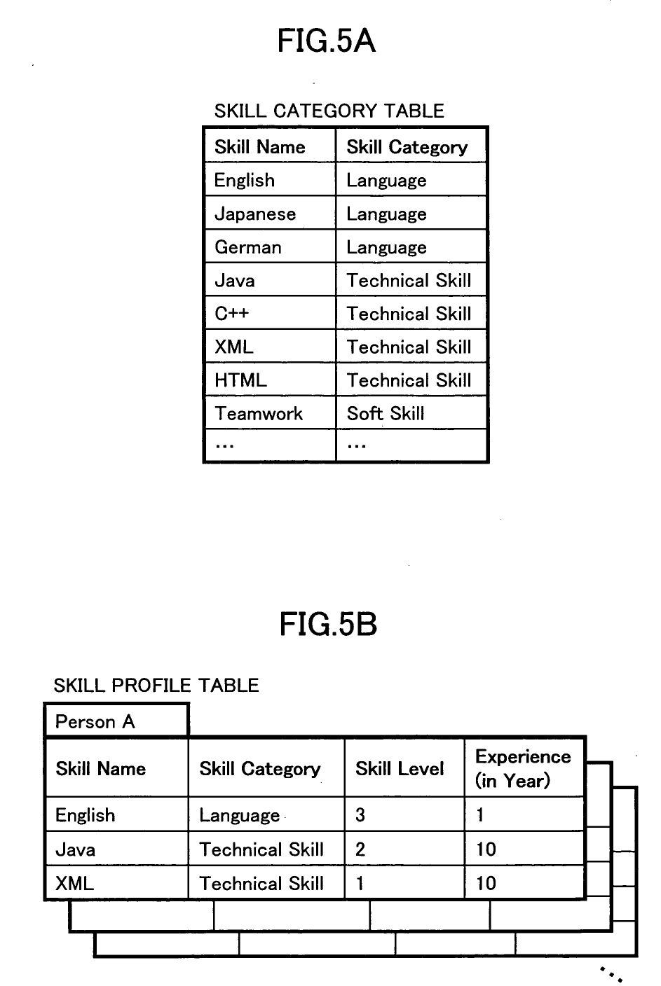

FIGS. 5A and 5B are diagrams showing a data constructional example of the skill information DB 236, and they show a skill category table and a skill profile table for each user (person), respectively. In FIG. 5A, the skill category table has the items of a “Skill Name” and a “Skill Category.” In FIG. 5B, the skill profile table has the items of a “Skill Name,” a “Skill Category,” a “Skill Level,” and “Experience (in years)” for each user such as “Person A.” In this example, the skill name “English” included in the skill category “Language” shows that the user “Person A” has the skill level of “3” and the experience value of “1” as an English skill, the skill name “Java” included in the skill category “Technical Skill” shows that the user has the skill level of “2” and the experience value of “10” as a Java skill, and the skill name “XML” included in the skill category “Technical skill” shows that the user has the skill level of “1” and the experience value of “10” as an XML skill.

(Operations at Generation and Ending of Task)

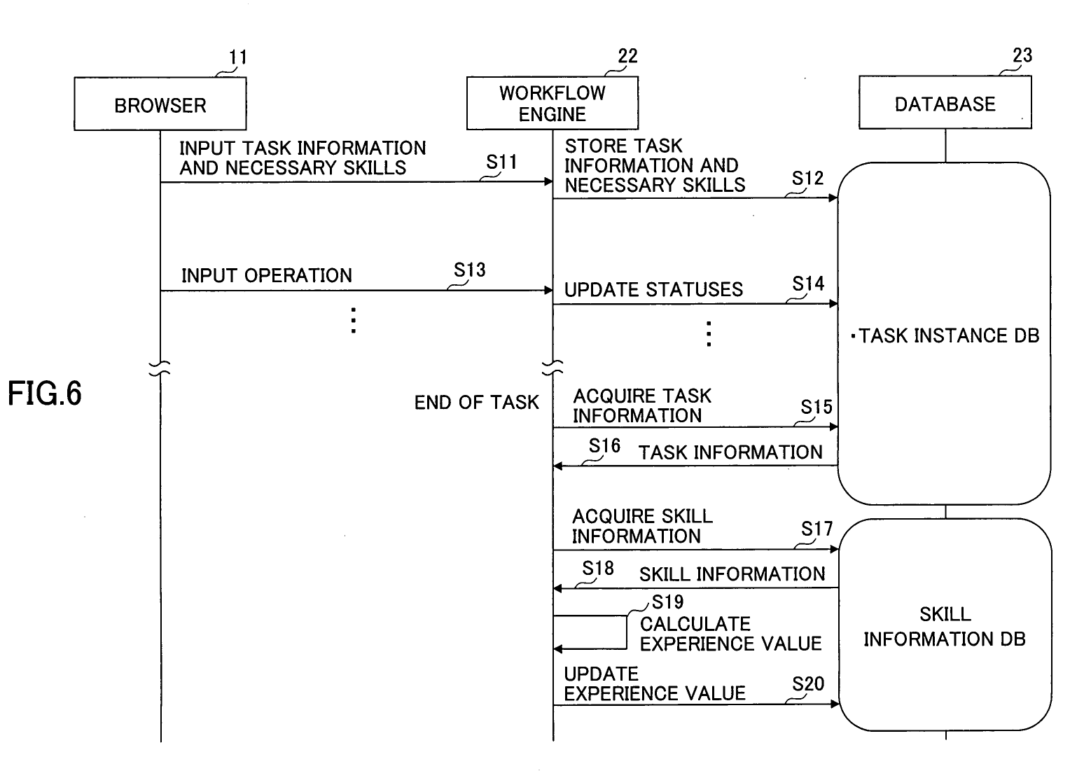

FIG. 6 is a sequence diagram showing a processing example at the generation and ending of a task in this embodiment.

At the generation of a new task, the user U first inputs general task information and necessary skills via the browser 11 (step S11). Upon receipt of this input, the task generation unit 223 of the workflow engine 22 generates the task instances of the new task in the task instance DB 233 and stores the input task information and the necessary skills therein (step S12). Note that in order to prevent influences on an existing module configuration, the necessary skills may be stored by a module other than the task generation unit 223.

Next, as the user performs various input operations in accordance with the progress of the task via the browser 11 (step S13), the task execution unit 224 updates the statuses of the task instance DB 233 (step S14).

Then, when the task execution unit 224 recognizes the ending of the task, the skill experience setting unit 227 acquires the corresponding task information of the task from the task instance DB 233 (steps S15 and S16).

Next, the skill experience setting unit 227 specifies a task executor based on the acquired task information and acquires the skill information of the task executor from the skill information DB 236 (steps S17 and S18).

Then, the skill experience setting unit 227 specifies the skill names of the skill information that match the skill names of the necessary skills included in the task information. If there is any matched skill name, the skill experience setting unit 227 converts the used hours of the task information into years and calculates as a new experience value the value obtained by adding the year-converted used hours to the experience value of the skill information for each skill name (step S19).

Next, the skill experience setting unit 227 updates the experience value of the corresponding skill information of the skill information DB 236 to the calculated experience value (step S20).

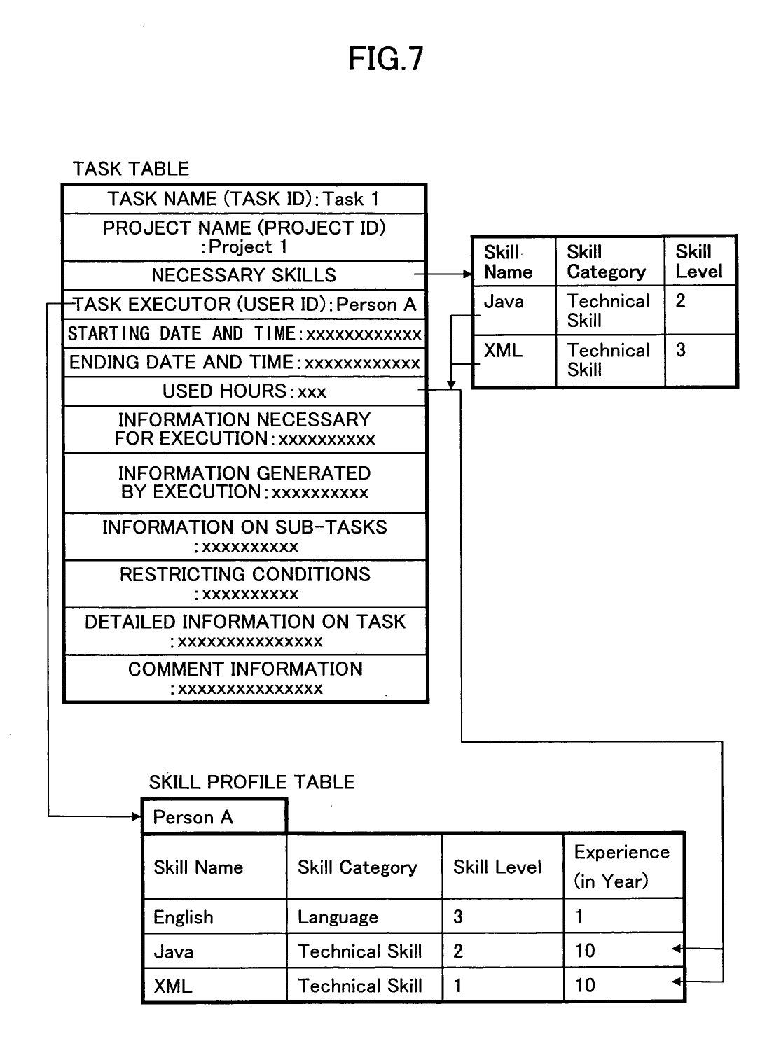

FIG. 7 is a diagram showing an example of setting a skill experience. Here, a corresponding skill profile table is specified based on the task executor “Person A” of the task table. After it is confirmed that the skill names “Java” and “XML” of necessary skills are included in the skill profile table, the values obtained by converting the used hours of the task table into years are added to the experience values of the skill profile table to update skill information.

(Operations at Search of Persons (Experts) or Tasks)

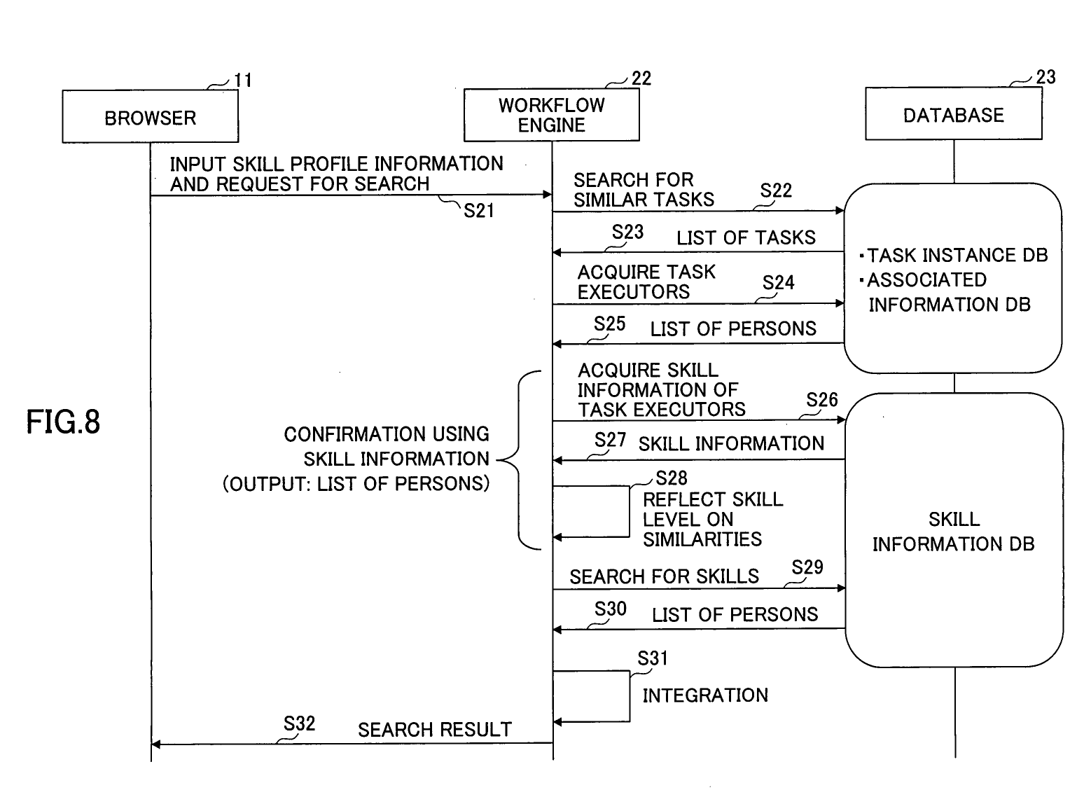

FIG. 8 is a sequence diagram showing a processing example at a search in the embodiment.

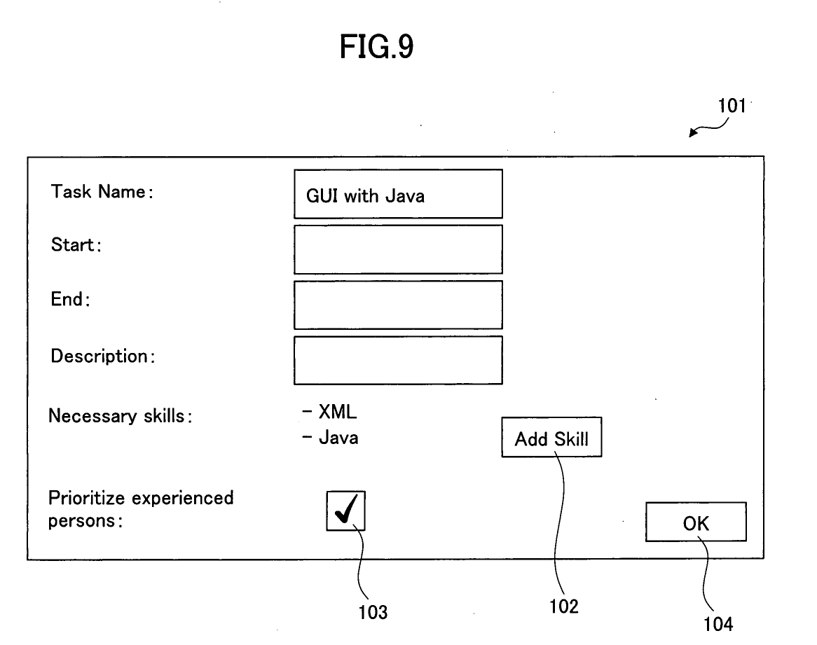

After the generation of a new task or the starting of an existing task, the user U first inputs skill profile information via the browser 11 and requests the workflow engine 22 to conduct the search (step S21). FIG. 9 is a diagram showing an example of a search screen 101. In the columns of a “Task Name,” a “Start (starting date and time),” an “End (ending date and time),” and a “Description (detailed information),” corresponding one of task information is displayed. Furthermore, when a skill addition button 102 is pressed and desired skill names are selected from a selection list not shown, the skill names are input in the column of a “Necessary Skills.” These skill names serve as skill profile information for specifying the skills. Furthermore, in order to conduct the search placing priority on the experience values of skills, an experience prioritizing check box 103 is checked. Note that if the skill information DB 236 has more detailed information than the skill information shown in FIG. 5, more specific skill profile information can be obtained with the input of not only skill names but also more detailed information.

Then, when a confirmation button 104 is selected, the search request is made.

Referring back to FIG. 8, the skill consideration search unit 228 searches for the similar tasks from the task instance DB 233 and the associated information DB 231 based on the task name and the detailed information of task information by using the function of the search engine (step S22). As a result, the workflow engine 22 acquires a list of the tasks from the task instance DB 233 and the associated information DB 231 (step S23). The list of the tasks includes searched for and retrieved task names and similarities.

Next, the skill consideration search unit 228 acquires task executors based on the task information of the tasks included in the list (step S24) and acquires a list of persons (step S25). The list of the persons includes person names, similarities (succeeded from those obtained by the processing of searching for the similar tasks), and task names. Note that it is possible to acquire not only the task executors but also associated persons including commentators (persons who make comments on the retrieved tasks) and delegating persons (persons who delegate the retrieved tasks) from the task information. In this case, it is preferred to weigh the associated persons in accordance with their roles in the subsequent processing.

Then, the skill consideration search unit 228 acquires skill information for each of the persons included in the list by using the function of the search engine 221 (steps S26 and S27).

Next, the skill consideration search unit 228 determines whether the skill names of the skill profile information are included in the skill information for each of the persons. If there is any skill name included in the skill information, the skill consideration search unit 228 determines the skill level corresponding to the skill name and reflects it on each of the similarities of the list of the persons (step S28).

Then, the skill consideration search unit 228 searches for skills in the skill information DB 236 based on the skill names of the skill profile information by using the function of the search engine (step S29). As a result, the skill consideration search unit 228 acquires a list of persons (step S30). The list of the persons includes person names, level averages, and experience value averages.

Next, the skill consideration search unit 228 integrates the list of the persons corrected in step S28 with the list of the persons acquired in step S30 and calculates total ranking points according to a prescribed formula (step S31). Then, the skill consideration search unit 228 presents a search result to the browser 11 via the GUI control unit 21 (step S32).

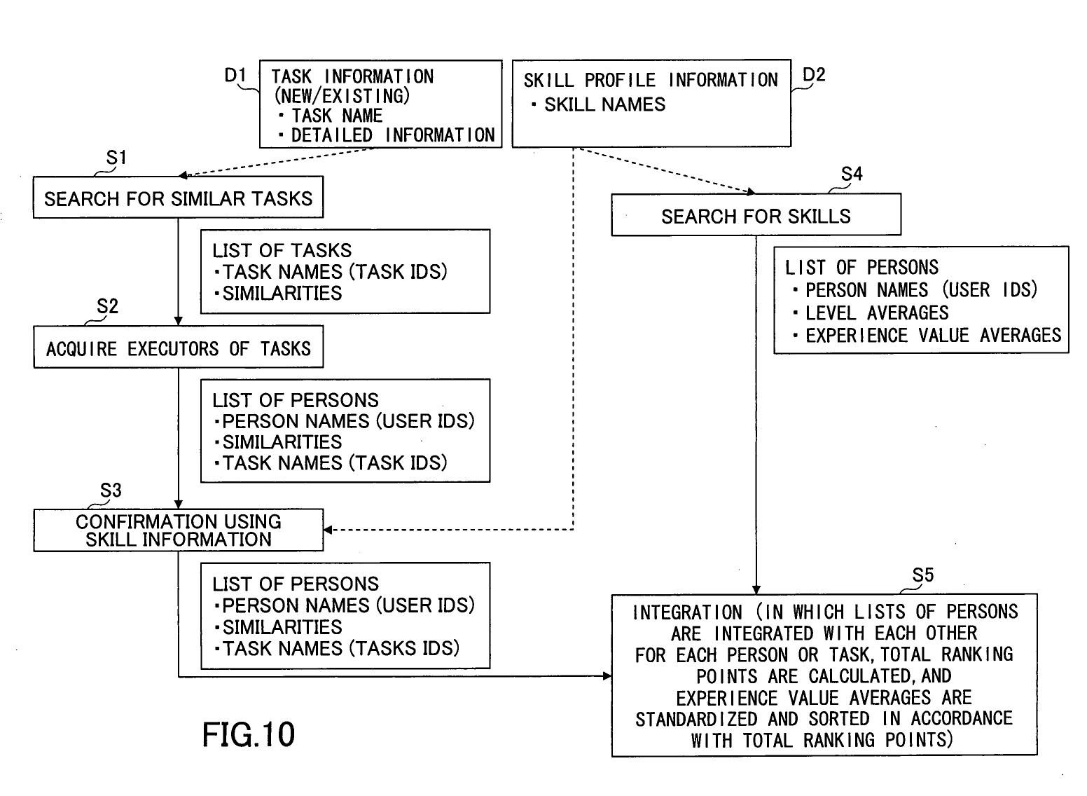

FIG. 10 is a diagram showing information (data) and the flow of processing at the search in the embodiment. Note that the processing is mainly performed by the skill consideration search unit 228.

First, in the processing of searching for similar tasks (step S1), similar tasks are searched for in the task instance DB 233, the associated information DB 231, or the like based on task information D1 such as a task name and detailed information included in either the task information input at the generation of a new task or the task information of an existing task. As a result of this processing, a list of the tasks including task names (task IDs) and similarities is output. The similarities are values determined according to the number of character strings of the task information D1 found to be used as a search keyword, their ratio, or their place. Note that the upper limit (maximum value) of the similarities are standardized to, for example, “100.”

Next, in the processing of acquiring task executors (step S2), task executors are acquired based on the task information (see FIG. 4) of the tasks included in the list according to the list of the tasks as the output of the processing of searching for the similar tasks (step S1). As a result of this processing, a list of the persons including person names (user IDs), similarities, and task names (task IDs) is output. The similarities succeed those obtained by the process of searching for the similar tasks. The task names represent those including associated persons.

Then, in the processing of performing confirmation using skill information (step S3), skill information is acquired from the skill information DB 23 based on the person names (user IDs) included in the list of the persons as the output of the processing of acquiring the task executors (step S2), and similarities are adjusted according to a result of whether the acquired skill information matches skill profile information D2 such as one or more skill names input by the user at the request of searching for the similar tasks. As a result of this processing, a list of persons including person names (user IDs), similarities, and task names (task IDs) is output. Here, the contents of the person names (user IDs) and the task names (task IDs) other than the similarities succeed the contents of the list of the persons as the output of the processing of acquiring the task executors (step S2). Here, in order to determine the similarities, the skill information of corresponding person names (user IDs) including the skill names of the skill profile information D2 are taken. In other words, the experience values of the skill information involved are averaged and standardized (upper limit: 100) and then further averaged with the experience values of the similarities that succeed those obtained in the previous step (i.e., the processing of searching for the similarities). Note that the experience values may be weighed with a predetermined amount instead of being simply averaged. Furthermore, the skill levels may be considered for adjusting the similarities in addition to the experience values.

Note that if no task is found in the processing of searching for the similar tasks (step S1) (the list of the tasks is blank), the processing of acquiring the task executors (step S2) and the processing for confirming the skill information (step S3) are not performed.

On the other hand, in the processing of searching for skills (step S4), skills are searched for in the skill information DB 236 based on the skill profile information D2 such as one or more skill names input by the user at the request of searching for the skills in parallel with the above processing. As a result of this processing, a list of persons including person names (user IDs), level averages, and experience value averages is output. The level averages are values obtained by averaging the levels corresponding to skill names for each of the person names (user IDs) found to include the skill name of the skill profile information D2 in the skill information. The upper limits (maximum values) of the level averages are standardized, for example, to “100.” The experience value averages are values obtained by averaging the experience values corresponding to skill names for each of the person names (user IDs) found to include the skill name of the skill profile information D2 in the skill information. The upper limits (maximum values) of the experience value averages are standardized, for example, to “100.”

Next, in the processing of performing integration (step S5), the list of the persons as the output of the processing of performing the confirmation using the skill information (step S3) and the list of the persons as the output of the processing of searching for the skills (step S4) are integrated. In other words, the lists are integrated for each person name (user ID) if it is desired to find persons (experts) associated with the task or the skill profile, or they are integrated for each task if it is desired to find tasks. Furthermore, total ranking points are calculated according to a prescribed formula based on the similarities, the level averages, and the experience value averages, and the values of the similarities, the level averages, and the experience value averages are standardized (upper limit: “100” for example) and sorted in accordance with the total ranking points.

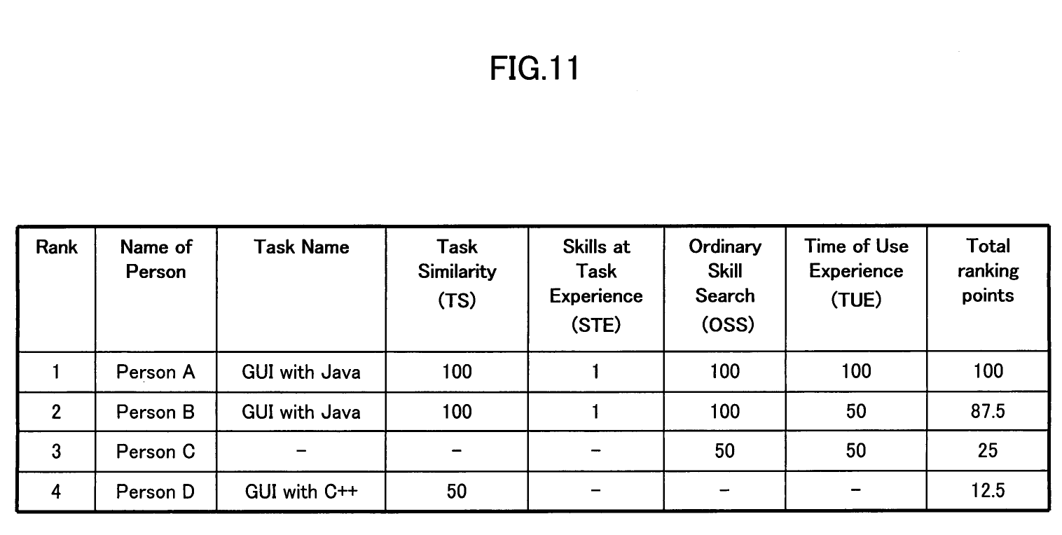

FIG. 11 is a diagram showing an example of an integration result in which the lists of persons are integrated for each person name (user IDs). From the leftmost column in FIG. 11, a “Rank,” a “Name of Person,” a “Task Name,” a “Task Similarity,” a “Skills at Task Experience,” an “Ordinary Skill Search,” a “Time of Use Experience,” and a “Total Ranking Points” are shown. The “Rank” represents the orders from the top with respect to the result sorted in accordance with the total ranking points described below. The “Name of Person (Person Name)” includes the person names obtained by the integration of the two lists of the persons.

The “Task Name” includes one or more task names corresponding to the person names. The “Task Similarity (TS)” includes the task similarities obtained by the integration of the lists of the persons corresponding to the person names. The “Skills at Task Experience (STE)” includes “1” input when the person names are acquired by the processing of searching for similar tasks and the processing of searching for skills and includes “0” input when the person names are not so acquired. This is because the person names acquired by the two types of searches are prioritized as those having high reliability. The “Ordinary Skill Search (OSS)” includes the values obtained by the integration of the level averages acquired in the processing of searching for the skills. The “Time of Use Experience (TUE)” includes the values obtained by the integration of the experience value averages acquired in the processing of searching for the skills. “Total ranking points” includes the values calculated according to the formula, for example, (0.25×TS)+STE×(0.25×OSS)+(0.25×OSS)+(0.25×TUE). Note that the variables are not limited to “0.25,” but they can be changed to appropriate values according to system operations.

In FIG. 11, “Person A” and “Person B” have full scores in the “Task Similarity (TS),” the “Skills at Task Experience (STE),” and the “Ordinary Skill Search (OSS).” However, “Person A” and “Person B” have “100” and “50,” respectively, in the “Time of Use Experience (TUE).” Therefore, “Person A” and “Person B” have “100” and “87.5,” respectively, in the “Total ranking points.” As a result, “Person A” is higher in “Rank” than “Person B.” “Person C” is acquired only in the processing of searching for the skills, and “Person D” is acquired only in the processing of searching for the similar tasks. Therefore, “Person C” and “Person D” have low total ranking points. Furthermore, “Person C” and “Person D” have the same score “50” in the “Ordinary Skill Search (OSS)” and the “Task Similarity (TS),” respectively. However, since the experience value of “Person C” is prioritized, “Person C” is higher in “Rank” than “Person D.”

As the display of a search result for the user U, all the information in FIG. 11 may be included. However, the “Rank,” the “Name of Person,” the “Task Name,” and the “Total Ranking Points” are satisfactory as the display. In this case, in order to facilitate accessing desired persons and tasks, individual person names and task names are hot-linked. Accordingly, it is possible to display the detailed information on the person names and the task names when the person names and the task names are clicked with a mouse. Moreover, in the case of the person names, it is possible to automatically open the sending form of an electronic mail to be sent to the persons.

Thus, according to the embodiment of the present invention, skill information is effectively used in the process of conducting a search, thereby making it possible to easily search for and retrieve appropriate human resources or tasks.

The present invention is not limited to the specifically disclosed embodiments, and variations and modifications may be made without departing from the scope of the present invention.

The present application is based on Japanese Priority Application No. 2008-070376 filed on Mar. 18, 2008, the entire contents of which are hereby incorporated herein by reference.

What is claimed is:

1. A workflow management system that dynamically constitutes a workflow model for executing a workflow, the system comprising:
a skill input unit through which skill information necessary for executing a new task is input for generating the new task;
an experience value update unit that calculates an experience value based on time from a start of the task to an end thereof at the ending of the task and updates the skill information of an executor of the task;
a task information acquisition unit that acquires task information including at least a task name and detailed information from a task in operation at a request of searching for a human resource or a task;
a skill profile information input unit from which skill profile information including at least a skill name is input at the request;
a similar task search unit that searches for an existing similar task based on the task information;
an associated person acquisition unit that acquires an associated person of the task searched for by the similar task search unit;
a confirmation unit that performs confirmation whether the associated person acquired by the associated person acquisition unit has consistency with the skill profile information;
a skill search unit that searches for the human resources having a common skill based on the skill profile information; and
an integration unit that calculates a ranking of the human resources or the tasks in consideration of the experience value based on an output from the confirmation unit and an output from the skill search unit and presents the calculated rankings in descending order.

2. A workflow management method for controlling a workflow management system that dynamically constitutes a workflow model for executing a workflow, the method comprising:
a skill input step of inputting skill information necessary for executing a new task for generating the new task;
an experience value update step of calculating an experience value based on time from a start of the task to an end thereof at the end of the task and updating the skill information of an executor of the task;
a task information acquisition step of acquiring task information including at least a task name and detailed information from a task in operation at a request of searching for a human resource or a task;
a skill profile information input step of inputting skill profile information including at least a skill name at the request;
a similar task search step of searching for an existing similar task based on the task information;
an associated person acquisition step of acquiring an associated person of the task searched for in the similar task search step;
a confirmation step of performing confirmation whether the associated person acquired in the associated person acquisition step has consistency with the skill profile information;
a skill search step of searching for the human resources having a common skill based on the skill profile information; and
an integration step of calculating a ranking of the human resources or the tasks in consideration of the experience value based on an output in the confirmation step and an output from the skill search step and presenting the calculated rankings in descending order.

3. A recording medium having recorded thereon a computer-readable workflow control program of a workflow management system that dynamically constitutes a workflow model for executing a workflow, the control program causing a computer constituting the workflow management system to function as:
a skill input unit through which skill information necessary for executing a new task is input for generating the new task;
an experience value update unit that calculates an experience value based on time from a start of the task to an end thereof at the ending of the task and updates the skill information of an executor of the task;
a task information acquisition unit that acquires task information including at least a task name and detailed information from a task in operation at a request of searching for a human resource or a task;
a skill profile information input unit from which skill profile information including at least a skill name is input at the request;
a similar task search unit that searches for an existing similar task based on the task information;
an associated person acquisition unit that acquires an associated person of the task searched for by the similar task search unit;
a confirmation unit that performs confirmation whether the associated person acquired by the associated person acquisition unit has consistency with the skill profile information;
a skill search unit that searches for the human resources having a common skill based on the skill profile information; and
an integration unit that calculates a ranking of the human resources or the tasks in consideration of the experience value based on an output from the confirmation unit and an output from the skill search unit and presents the calculated rankings in descending order.
